(19) United States
(12) Patent Application Publication
(10) Pub. No.: US 2006/0059221 A1
(43) Pub. Date: Mar. 16, 2006

(54) Multiply instructions for modular exponentiation

(75) Inventor: David A. Carlson, Haslet, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Cavium Networks, Santa Clara, CA (US)

(21) Appl. No.: 11/044,648

(22) Filed: Jan. 27, 2005

Related U.S. Application Data
(60) Provisional application No. 60/609,211, filed on Sep. 10, 2004.

(51) Int. Cl. G06F 7/52

(52) U.S. Cl. 708/620

(57) ABSTRACT

A method and apparatus for increasing performance of a multiplication operation in a processor. The processor's instruction set includes multiply instructions that can be used to accelerate modular exponentiation. Prior to issuing a sequence of multiply instructions for the multiplication operation, a multiplier register in a multiply unit in the processor is loaded with the value of the multiplier. The multiply unit stores intermediate results of the multiplication operation in redundant format. The intermediate results are shifted and stored in the product register in the multiply unit so that carries between intermediate results are handled within the multiply unit.

### RELATED APPLICATION

This application claims the benefit of U.S. Provisional Application No. 60/609,211, filed on Sep. 10, 2004. The entire teachings of the above application are incorporated herein by reference.

### BACKGROUND OF THE INVENTION

Modular exponentiation (that is, raising an integer to an integer power mod n) is a well-known operation that is used in cryptographic algorithms, such as Rivert, Shamir, Aldeman (RSA), Diffie-Hellman key exchange, and Digital Signature Algorithm (DSA). Typically, there are at least 512-bits in the operands of a cryptographic algorithm. The modular exponentiation is performed using an exponentiation algorithm that performs the exponentiation using a series of multiplications.

The fundamental operation used in the exponentiation algorithm is to multiply a multiplier by a multiplicand and add the result of the multiplication operation to an accumulator. The accumulator typically has 512 to 2048 bits. For example the operation below adds the result of multiplying n-bits of B (multiplicand) by k-bits of A (multiplier) to P (accumulator):
P[k+n−1:0]+=A[k−1:0]×B[n−1:0]

The parameter ‘n’ is typically 512 bits to 2048 bits and ‘k’ is a convenient word size, for example, 64-bits. The number of times that this operation is performed for each word size k is dependent on the number of digits in the multiplicand; that is, on the value of n. For example, with a word size of 64-bits, the operation is performed (8×n) times for a 512-bit multiplier (n=512) and (32×n) times for a 2048-bit multiplier (n=2048).

In a processor, each multiply instruction typically has a latency of four or more processor instruction cycles. In some processors, a multiply unit provides all of the product bits at the end of the multiply instruction but there is no single instruction that returns all of the product bits to the processor's register file, hence two separate instructions are required to move the results of the multiplication operation to the register file. For example, in the MIPs instruction set, the MFLO, MFHI instructions move the product bits to the register file. In these processors, the multiply instruction has a minimum latency of six instruction cycles (four instruction cycles for the multiply and an additional two instruction cycles for the move). Latency cannot be reduced through pipelining because the move instructions to transfer the result from the multiply unit to the register file prevent pipelining.

Other processors have multiply instructions which can be more easily pipelined. Two separate multiply instructions are provided, one instruction returns the low-order bits of the result and another instruction returns the high-order bits of the result. In these processors, each instruction takes at least one instruction cycle and additional instructions are required to fetch, add, and store, the accumulator being careful with carries between the low-order result and the high order result.

### SUMMARY OF THE INVENTION

Multiply instructions according to the principles of the present invention accelerate modular exponentiation by providing efficient multiplication. The multiply unit includes a multiply register in which the multiplier is loaded once at the beginning of a multiplication operation (that is, at the beginning of a loop to issue a plurality of multiply instructions for a large multiplication operation). By storing the multiplier once at the beginning of the multiplication operation, the throughput of the multiply intensive operation is increased. The throughput of the multiplication operation is also increased by increasing the size of the multiplier that can be stored in the multiply unit to decrease the number of multiply instructions issued.

A processor includes a multiply unit and a register file. The multiply unit includes a multiplier register and a product register. The register file includes a plurality of general purpose registers for storing a result of a multiplication operation in the multiply unit. The multiplier register is loaded once with a multiplier value prior to the start of the multiplication operation that includes a plurality of multiplication instructions. The intermediate results of each multiplication instruction are shifted and stored in the product register so that carries between intermediate results are handled within the multiply unit.

The multiplication operation may be one of a sequence of operations performed for modular exponentiation. The product register may be cleared when the multiplier register is loaded. The multiply instruction may also be used to perform an add operation by storing 1 in the multiplier register prior to issuing the multiply instruction.

The multiplier register is loaded using an instruction to load the multiplier register. In one embodiment the multiply instruction may perform a multiplication operation for a 64-bit multiplier and a 64-bit multiplicand. In alternate embodiment, the multiply instruction performs a multiplication operation for a 192-bit multiplier and a 64-bit multiplicand with the 192-bit multiplier being stored in the multiplication register in the multiply unit prior to the start of the multiplication operation. The intermediate result may be stored in redundant format.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a Reduced Instruction Set Computing (RISC) processor having an instruction set that includes a multiply instruction that accelerates modular exponentiation according to the principles of the present invention;

FIG. 2 is a block diagram of an embodiment of the multiply unit shown in FIG. 1;

FIG. 3 is a block diagram illustrating the operation of a move instruction to store data in a register in the multiply unit;

FIG. 4 illustrates the format of a 64-bit×64-bit multiply instruction processed by the multiply unit shown in FIG. 1;

FIG. 5 is a flowchart illustrating the operation of the 64-bit×64-bit multiply instruction shown in FIG. 4;

FIG. 6 is a diagram of a 192-bit×64-bit multiply instruction processed by the multiply unit shown in FIG. 1;

FIG. 7 is a flowchart illustrating the operation of the 192-bit×64-bit multiply instruction shown in FIG. 6;

FIG. 8 is a flowchart illustrating a context switch that results in saving the state of the multiply unit;

FIG. 9 is a flowchart illustrating a context switch that results in restoring the state of the multiply unit;

FIG. 10 is a block diagram of a security appliance including a network services processor including at least one RISC processor shown in FIG. 1; and

FIG. 11 is a block diagram of the network services processor 700 shown in FIG. 10.

### DETAILED DESCRIPTION OF THE INVENTION

A description of preferred embodiments of the invention follows.

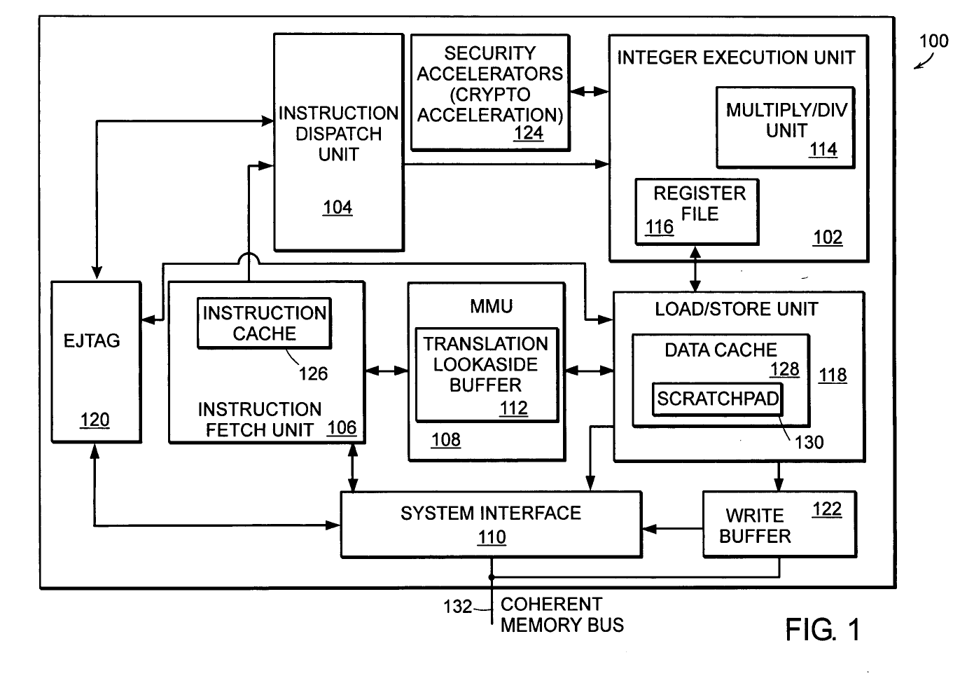

FIG. 1 is a block diagram of a Reduced Instruction Set Computing (RISC) processor 100 having an instruction set that includes a multiply instruction that accelerates modular exponentiation according to the principles of the present invention. instructions. The processor 100 includes an Execution Unit 102, an Instruction dispatch unit 104, an instruction fetch unit 106, a load/store unit 118, a Memory Management Unit (MMU) 108, a system interface 110, a write buffer 122 and security accelerators 124. The processor core also includes an EJTAG interface 120 allowing debug operations to be performed. The system interface 110 controls access to external memory, that is, memory external to the processor, such as level 2 (L2) cache memory over a coherent memory bus 132.

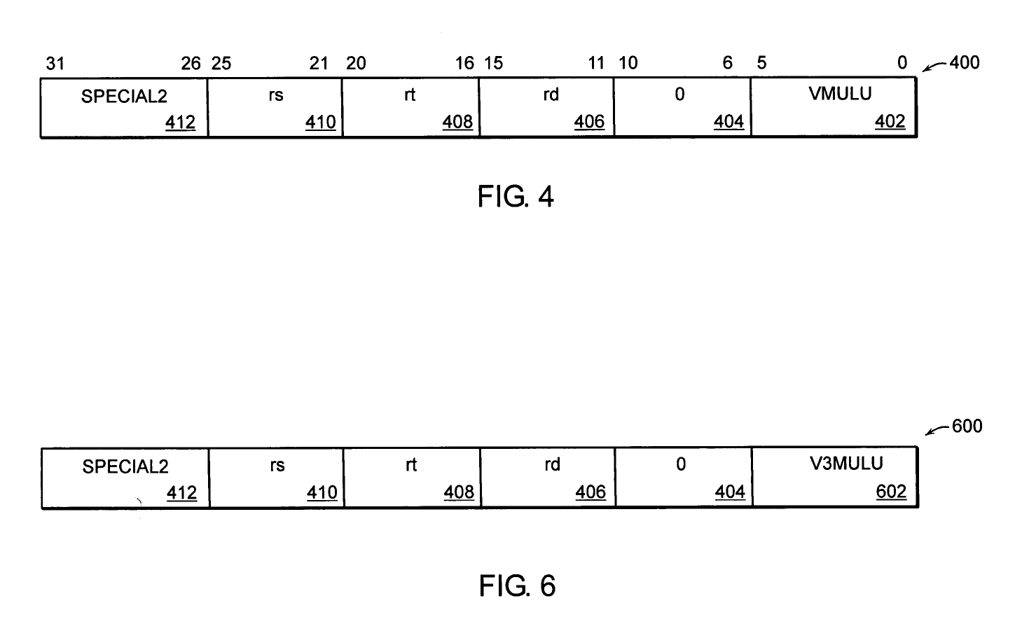

The Execution unit 102 includes a multiply unit 114 and at least one register file 116. The multiply unit 114 provides the result of a multiplication operation on a multiplicand by a multiplier. Instructions that allow efficient multiplication according to the principles of the present invention will be described later in conjunction with FIGS. 4-7. The multiply instructions allow acceleration of modular exponentiation, which is used for security processing to process cryptographic algorithms such as Rivert, Shamir, Aldeman (RSA), Diffie-Hellman key exchange, and Digital Signature Algorithm (DSA).

The Instruction fetch unit 106 includes instruction cache 126. The load/store unit 118 includes data cache 128. In one embodiment the instruction cache 126 is 32K bytes, the data cache 128 is 8K bytes and the write buffer 122 is 2K bytes. The Memory Management Unit 108 includes a Translation Lookaside Buffer (TLB) 112.

In one embodiment, the processor 100 includes a crypto acceleration module (security accelerators) 124 that include cryptography acceleration for Triple Data Encryption standard (3DES), Advanced Encryption Standard (AES), Secure Hash Algorithm (SHA-1), and Message Digest Algorithm #5 (MD5). The crypto acceleration module 124 communicates by moves to and from the register file 116 in the Execution unit 102. The security instructions that control the security accelerators are advantageous for processing secure packets. The security instructions can also be used to accelerate common packet-processing operations. For example, Cyclic Redundancy Check (CRC) is commonly used to generate hash values needed for packet lookups. Other crypto engines could also be used.

A superscalar processor has a superscalar instruction pipeline that allows more than one instruction to be completed each clock cycle by allowing multiple instructions to be issued simultaneously and dispatched in parallel to multiple execution units. The RISC-type processor 100 has an instruction set architecture that defines instructions by which the programmer interfaces with the RISC-type processor. Only load and store instructions access external memory; that is, memory external to the processor 100. In one embodiment, the external memory is accessed over a coherent memory bus 134. All store data is sent to external memory over the coherent memory bus 132 via a write buffer entry in the write buffer. All other instructions operate on data stored in the register file 116 in the processor 100. In one embodiment, the processor is a superscalar dual issue processor, there are two instruction pipelines allowing two instructions to be processed in parallel.

The instruction pipeline is divided into stages, each stage taking one clock cycle to complete. Thus, in a five stage pipeline, it takes five clock cycles to process each instruction and five instructions can be processed concurrently with each instruction being processed by a different stage of the pipeline in any given clock cycle. Typically, a five stage pipeline includes the following stages: fetch, decode, execute, memory and write back.

During the fetch-stage, the instruction fetch unit 106 fetches an instruction from instruction cache 126 at a location in instruction cache 128 identified by a memory address stored in a program counter. During the decode-stage, the instruction fetched in the fetch-stage is decoded by the instruction dispatch unit 104 and the address of the next instruction to be fetched for the issuing context (process) is computed. During the execute-stage, the Integer Execution unit 102 performs an operation dependent on the type of instruction. For example, the Integer Execution Unit 102 begins the arithmetic (e.g. multiplication) or logical operation for a register-to-register instruction, calculates the virtual address for a load or store operation or determines whether the branch condition is true for a branch instruction. During the memory-stage, data is aligned by the load/store unit 118 and transferred to its destination in external memory. During the write back-stage, the result of a register-to-register or load instruction is written back to the register file 116.

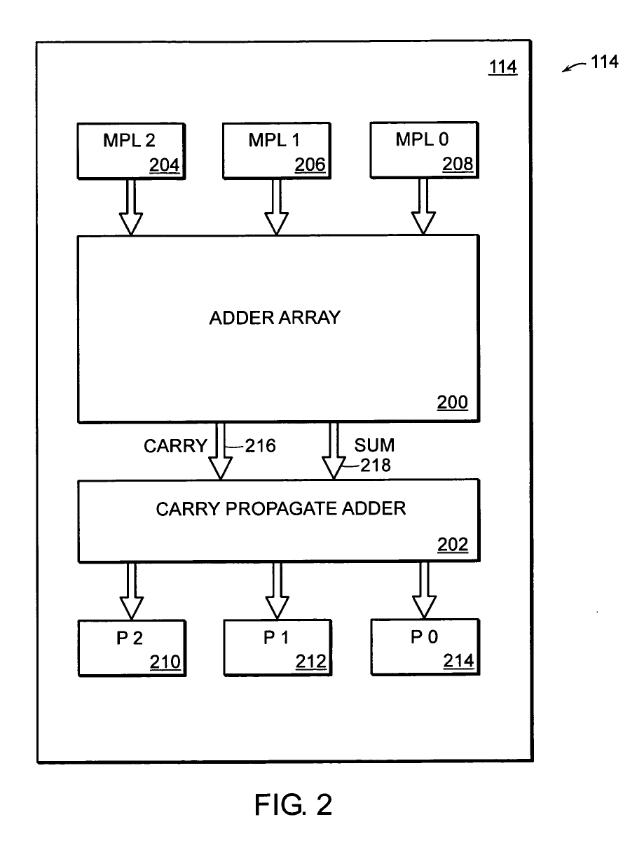

FIG. 2 is a block diagram of an embodiment of the multiply unit 114 shown in FIG. 1. The multiply unit 114 includes an array of adders (adder array) 200, a carry propagate adder 202, a plurality of multiplier registers 206, 208, 210 and a plurality of product registers P0-P2 210, 212, 214. As is well-known in the art, a multiplication operation can be performed using a series of add operations where the number to be added (multiplicand) is added a number of times (multiplier) and the final result of the series of add operations is the product. For example, to multiply 3×4, ‘3’ (multiplicand) is added ‘4’ (multiplier) times and the result (product) is ‘12’. In one embodiment, the adders in the array of adders are Carry Save Adders (CSA) configured as a Wallace tree. The array of adders 200 provides a partial product in the form of a sum 218 and a carry 216. The partial product is provided to the Carry Propagate Adder (CPA) 202 to provide the product which is stored in product registers P0-P2 210, 212, 214.

Typically, in prior art multipliers, the following processor instructions are issued to perform one multiplication operation (e.g. to compute product[n+k]=mplier[k]*mplicand[n]) in a processor with prior art multiply units:
Product[0]=0
For i=0 to N-1
   Temp=mplicand[i]*mplier
   Product[i]+=Tempₗₒ
   Product[i+1]=Tempₕᵢ

As shown, both the multiplier and the multiplicand are loaded into the multiply unit in each iteration and two instructions are issued to read the result from the multiply unit (one to read the low order bits of the result from Tempₗₒ and the other to read the high order bits of the result from Tempₕᵢ.) For example, two instructions are required to read a 64-bit result, one to read the low order 32-bits and the other to read the high order 32-bits.

Multiply instructions according to the principles of the present invention allow efficient multiplication by using the following sequence of instructions:
Product[0] =0
MTM0 mplier
For i=0 to N-1
   VMULU product[i], mplicand[i], product[i]

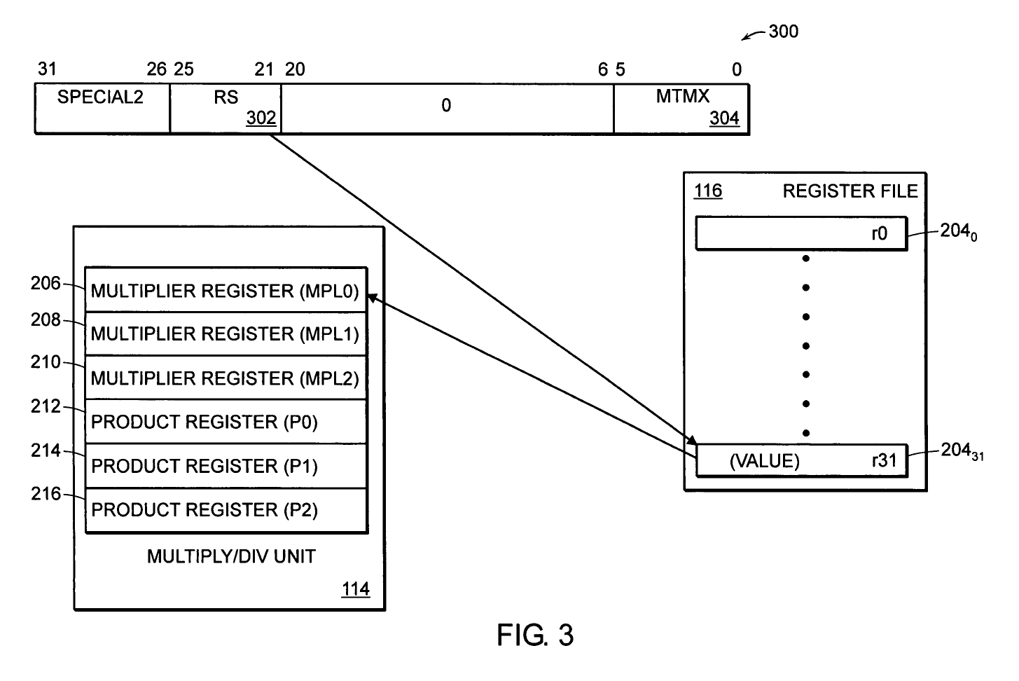

Instead of loading the multiplier into the multiply unit 114 in each iteration as in the prior example, the multiplier register load instruction (MTM) allows the multiplier to be stored in multiply registers 204₀-204₃₁, 206, 208 in the multiply unit 114. The multiplier register load instruction (MTM) will be described later in conjunction with FIG. 3. As the stored multiplier value is used for subsequent issued multiply instructions for the same multiplication operation, storing the multiplier in the multiply unit 114 reduces the number of load instructions that are issued. In one embodiment, each multiplier register is 64-bits wide (the processor word size), allowing a 192-bit multiplier to be loaded into the multiplier registers (with 64-bits of the 192-bit multiplier stored in each multiply register 206, 208, 210).

The number of instructions to obtain the result from the multiply unit is also reduced through the addition of product registers. The multiply instruction (VMULU) uses the multiplier stored in the multiplier registers and shifts the result appropriately so that carries are handled within the multiply unit. The result of each multiplication operation is stored in product registers P0 210, P1 212, P2 214, in an embodiment with each product register being 64-bits wide, a 192-bit result can be stored internally in the multiply unit. The carry propagate adder 202 computes the result of the add operation on the multiplicand and the multiplier using the carry 216 and sum 218 output from the adder array 200.

The Carry Propagate Adder (“CPA”) propagates a carry bit from the least significant bit (“LSB”) to the most significant bit (“MSB”). The array of adders includes a plurality of Carry Save Adders (“CSAs”). A CSA saves carry bits and does not require propagating a carry bit from the LSB to the MSB. As a result, a CSA is much faster than a CPA.

Although the product and multiplier registers are shown as separate storage from the array of adders 200 and the carry propagate adder 202, the low order bits of the product are moved directly from the carry propagate adder (CPA) 202 to a register in the main register file bypassing the product registers.

The product is stored in the carry propagate adder 202 and array of adders 200 in redundant format, so that the product can be computed efficiently. As is well-known in the art, instead of selecting digits from the binary set {0, 1}, the product can be stored in redundant format using digits selected from a redundant set of digits. In one embodiment, the product is stored in redundant format using digits selected from the redundant set of digits {0, 1, 2}. In other embodiments, the digits can be selected from the redundant set of digits {−1, 0, 1} or the redundant set of digits {−2, −1, 0, 1, 2}. Adders that store results in redundant format are well-known to those skilled in the art.

FIG. 3 is a block diagram that illustrates registers in the main register file 116 and the multiply unit 114. FIG. 3 also illustrates an instruction 300 for loading values from registers in the main register file 116 to registers in the multiply unit 114. As discussed in conjunction with FIG. 2, the multiply unit 114 includes three 64-bit multiplier registers (MPL0, MPL1, MPL2) and three product registers (P0, P1 and P2). The multiply instructions executed in the multiply unit 114 use the multiplier stored in one or more of the multiplier registers 206, 208, 210 and store the product in one or more of the product registers 212, 214, 216. The multiply instructions will be described later in conjunction with FIGS. 4-7.

Instructions are provided in the processor's instruction set for loading values stored in registers in the main register file 116 into the multiply registers MPL0-MPL2. In the embodiment shown, the load instruction 300 is 32-bits wide. The format of the load instruction is MTMx rs. The opcode stored in the opcode field 304 in the instruction is ‘MTMx’ with ‘x’ identifying the particular multiply register (0-2) to be loaded. The ‘rs’ field 202 in the load instruction 300 identifies the register in the register file 116 in which the value to be loaded in the identified multiply register has been stored.

In the embodiment shown, with a 32-bit wide instruction and 32 registers in the register file (numbered 0 through 31) and each register capable of storing a 64-bit doubleword value. When executed, the instruction MTM0, r31 loads the 64-bit double word value stored in register 31 204₃₁ into multiply register 0 (MPL0) 206.

Generally, the product registers (P0-P2) are cleared at the start of a multiplication operation, that is, when the multiplier register (MPL0-MPL2) is loaded with the multiplier value. Thus, in addition to loading MPL0 206, the multiply register load instruction also initializes product registers P0-P2 212, 214, 216 by storing 0 in each product register P0-P2. By also clearing the product registers, the MTMx instructions reduce the number of instructions to be issued to initialize the multiply unit 114 at the start of the multiplication operation.

The instruction set includes other instructions (MTPx) to load the product registers P0-P2. The format of the product register load instructions is similar to the multiply register load instructions with ‘x’ identifying the number of the product register to be loaded. For example, the instruction ‘MPT0, r2’ loads the P0 register 212 with the value stored in the r2 register 204₂ in the register file. Typically, the instructions to load the product registers (P0-P2) are used to restore state in the multiply unit after a context switch which will be discussed later in conjunction with FIG. 9.

FIG. 4 illustrates the format of a 64-bit by 64-bit multiply instruction according to the principles of the present invention. The instruction is 32-bits wide and includes an op-code field 402 and fields 406, 408, 410 for identifying registers (rd, rt, rs) in the register file 116 in the execution unit 102 in the core 100. Field 404 is set to ‘0’ and field 402 identifies the instruction as a special instruction.

This instruction performs a multiply for a 64-bit multiplicand and a 64-bit multiplier. The operation code (VMULU) stored in the op-code field 402 in the instruction 400 indicates the type of multiply to be performed.

The multiply instruction allows efficient multiplication. As the multiplier and multiplicand are limited to 64-bits, the VMULU multiply instruction is issued multiple times in order to perform a multiplication operation having operands (multiplier, multiplicand) having greater than 64-bits. Each time that the 64-bit by 64-bit multiply instruction is issued is referred to as an iteration. Prior to issuing the first multiply instruction, the word size is selected and the multiplier is loaded into a multiplier register (MPL0) in the multiply unit. Example code for performing a multiplication operation with operands greater than 64-bits is shown below:
Product[0]=0
Offset=0
MTM0 multiplier
For i=0 to n-1
   LD rs, offset (multiplicand_ptr)
   VMULU rd, rs, rt
   Offset+=8

The MTM0 instruction loads multiplier register 0 (MPL0 208 (FIG. 2)) with the multiplier. Then, the multiplicand is loaded into a register in the register file and the 64-bit multiply instruction VMULU is issued n times. For example, for a 512-bit×64-bit multiplication operation, the instructions within the loop (e.g. load and 64-bit×64-bit multiply instruction VMULU) are issued eight times with each instruction performing a 64-bit multiplication operation on a different 64-bit segment of the multiplicand; that is, the multiplicand_ptr is incremented by the offset (8) each time to load the next 64-bit segment of the multiplicand. The 64-bit multiply instruction is most efficient for multiplication operations with operands having less than 1024-bits.

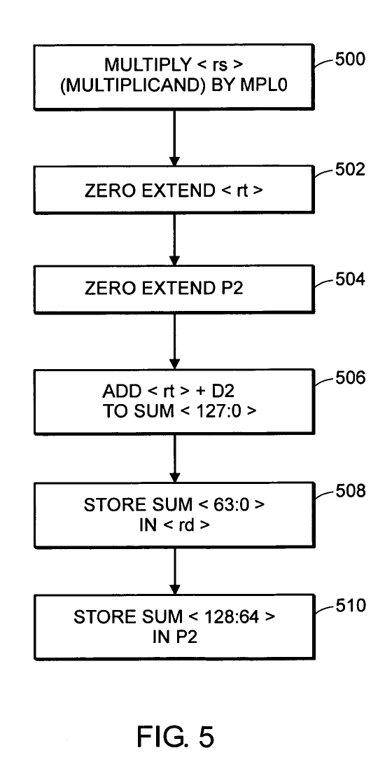

FIG. 5 is a flowchart illustrating the operation of the 64-bit multiply instruction. The flowchart will be described in conjunction with FIG. 4.

Prior to issuing the multiply instruction, the multiplicand, a 64-bit doubleword value, is stored in the rs register in the register file. The multiplier, a 64-bit doubleword value, is stored in multiplier register 0 (MPL0). With the accumulator being stored in the register file, the instruction sequence for each iteration (that is, within the for loop described previously) is:
LD $1, offset (multiplicand_ptr)
VMULU $10, $1, $10

The load instruction moves 64-bits of the multiplicand stored at the multiplicand_ptr+offset into register 1 in the main register file. The offset is initially set to 0 and incremented by 8 at the end of each iteration to load the next 64-bits of the multiplicand into register 1 in the main register file. The 64-bit multiply instruction (VMULU) multiplies the 64-bits of the multiplicand stored in register 1 by the multiplier stored in the multiplier register. In a dual-issue processor, the load instruction can be issued in parallel with the multiply instruction, i.e. only 1 instruction cycle is used. The VMULU instruction (VMULU rd, rs, rt) performs the following function {P2, rd}={0, P2}+{0, rt}+rs*{MPLO} which will be described conjunction with the flowchart in FIG. 5.

At step 500, the 64a-bit double word value (multiplicand) stored in the rs (register 1) register in the main register file is multiplied by the 64-bit double word stored in the multiplier register MPL0. Both operands are treated as unsigned values. The result is 128-bits.

At step 502, the 64-bit value stored in the rt register (register 10) is zero extended to provide a 128-bit value with the most significant 64-bits set to 0.

At step 504, the 64-bit value stored in product register P2 is zero extended to provide a 128-bit value with the most significant 64-bits set to 0.

At step 506, the 128-bit zero extended rt value, the 128-bit zero extended P2 value and the 128-bit result are added.

At step 508, the lower 64-bits of the 128-bit result are stored in the rd register (register 10) in the main register file.

At step 510, the upper 64-bits of the 128-bit result are stored in the product register P2 for use in the next iteration. Product registers P0 and P1 are not used.

The next time the 64-bit multiply and add instruction is issued, the value stored in the product registers is right shifted by 64 bits and the shifted value is then added into the result of the current multiplication operation. The P2 register stores the upper 64-bits of the sum from the previous instruction. Thus, the multiply unit uses the entire 128-bit product to provide the result of a subsequent multiplication operation and thus can easily handle the addition and carry propagation between the upper 64-bits and the lower 64-bits of the 128-bit result.

FIG. 6 illustrates the format of a 192-bit×64-bit multiply and add instruction 600 according to the principles of the present invention. The 192-bit×64-bit multiply instruction is most efficient for multiplication operations with operands having at least 1024-bits.

The instruction 600 is 32-bits wide and includes an op-code field 602 and fields 406, 408, 410 for identifying registers (rd, rt, rs) in the register file 116 in the execution unit 102 in the core 100. Field 404 is set to 0 and field 402 identifies the instruction as a special instruction.

This instruction performs a multiply for a 192-bit multiplier and a 64-bit multiplicand. The operation code (V3MULU) stored in the op-code field 602 in the instruction 600 indicates the type of multiply instruction to be performed.

The 192-bit multiply instruction allows efficient multiplication. As the multiplicand is limited to 64-bits and the multiplier to 192-bits, the V3MULU multiply instruction is issued multiple times in order to perform a multiplication operation with operands (multiplier, multiplicand) having greater than 64-bits. Each time that the 192-bit multiply instruction is issued is referred to as an iteration. Prior to issuing the first multiply instruction, the word size is selected and the 192-bit multiplier is loaded into multiplier registers (MPL0-2) in the multiply unit. Example code for performing a multiplication operation with operands greater than 64-bits is shown below:
product[0]=0
MTM0 multiplier
MTM1 multiplier
MTM2 multiplier
For i=0 to n-1
   V3MULU product[i], mplicand[i], product[i]

Three multiplier load instructions are issued prior to the start of the multiplication operation. The first multiplier load instruction (MTM0) loads multiplier register 0 MPL0 with the least significant 64-bits of the 192-bit multiplier. The second multiplier load instruction loads multiplier register 1 MPL1 with the next 64 bits of the 192-bit multiplier. The third multiplier load instruction loads multiplier register 2 MPL2 with the 64 most significant bits of the 192-bit multiplier. The 64-bit×192-bit multiply instruction is issued n times. For example, for a 1024-bit×192-bit multiply operation, the 64-bit×192a-bit multiply instruction is issued sixteen times.

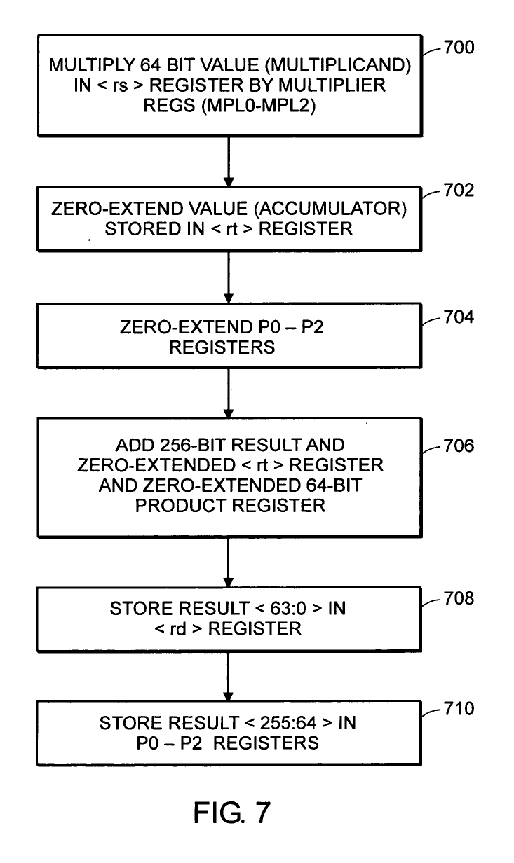

FIG. 7 is a flowchart illustrating the operation of the 192-bit multiply instruction. The flowchart will be described in conjunction with the instruction shown in FIG. 6.

The register file is not big enough to hold the working accumulator for large multiplication operations. Thus, the accumulator is stored in the data cache in the processor core. In this embodiment, the following instructions are issued during each iteration to perform a multiply instruction:
LD $1, offset (multiplicand_ptr)
LD $2, offset(accum_ptr)
V3MULU $3, $1, $2
SD $3, offset(accum_ptr)

Three memory operations (represented by the load/store (LD/SD) instructions) are issued during each iteration, each memory operation takes 1 instruction cycle. The 192-bit×64-bit instruction V3MULU is issued to perform the multiplication operation. The multiplier takes 3 instruction cycles to perform the multiply. The three instruction cycles taken by the multiplier match the 3 memory operations each taking one instruction cycle. In a dual-issue processor, with the memory instructions issued in parallel with the multiply instruction, each iteration is 3 instruction cycles. However, the number of iterations is reduced by a third in comparison to using the 64-bit×64-bit multiply instruction (VMULU). Thus, both cases achieve roughly the same performance.

Prior to issuing the 192-bit×64-bit multiply instruction, the 192-bit multiplier is stored in the multiplier. The V3MULU instruction performs the following function {P2, P1, P0, rd}={0, P2, P1, P0}+{0, 0, 0, rt}+rs*{MPL2, MPL1, MPL0} which will be described in conjunction with the flowchart in FIG. 7.

At step 700, the 192-bit multiplier stored in the three multiplier registers MPL0-2 is multiplied by the multiplicand stored in the register file.

At step 702, the value stored in the rt register (accumulator) is zero extended.

At step 704, the 192-bit value stored in the product registers P0-P1 is zero extended.

At step 706, the 256-bit result, zero extended value product register value and zero extended rt register value are added.

At step 708, the least significant bits (bits 63:0) of the result of the addition are stored in the rd register in the register file.

At step 710, the other 192-bits of the result (bits 255:64) of the result of the addition are stored in the product registers P2:P0 for the next iteration.

The next time the multiply instruction is issued, the 192-bits stored in the multiplier registers in the multiply unit are right shifted by 64 and added to the next product. Thus the multiply unit uses all of the product and thus easily handles the addition and carry propagation.

The invention has been described for a multiplier having K bits where k is 64 or 192 in a 64-bit processor. K is decoupled from the fundamental machine size. The same performance can be provided on a 32-bit processor. To do this K=128 or K=384. In this embodiment, as the multiplicand is half size (32 bits instead of 64 bits), the multiplier is doubled (384 bits instead of 192 bits to do the same amount of work). Thus, the multiply instruction can be easily modified by one skilled in the art by selecting an appropriate value of K to achieve any level of modular exponentiation performance desired, at the cost of more or less multiplier hardware.

For example, for a 64-bit processor if K=128 or K=384, the inner loops are the same as described for the 64-bit processor with K=64 or K=192. The number of iterations is decreased, with only half as many iterations required. However, the multiplier hardware is doubled.

In order to increase processing of the multiplication operation, the multiplier and product are stored internally in the multiply unit. However, these values must be stored anytime that there is a context switch, that is, when a task involving an operation in the multiply unit is de-scheduled to allow another task to be scheduled. For example, a process switch or context switch occurs when the processor switches from one process (running program plus any state needed for the program) to another process. On a context switch, the state of the process that is switched out is saved. The state of the switched-out process is restored on a subsequent context switch when the process is re-scheduled. When processing a modular exponentiation, the current state of the multiplier is stored in the multiplier and product registers in the multiplier registers. Therefore, to allow context switching, the state of these registers is saved.

The assembly code shown in Table 1 below can be used to save multiplier context.

TABLE 1

| la | $ka, multiplier_context | |
|---|---|---|
| v3mulu | $v0, $0, $0 | //p0 |
| v3mulu | $v0, $0, $0 | //p1 |
| sd | $v0, 0($ka) | |
| v3mulu | $v0, $0, $0 | //p2 |
| sd | $v1, 8($ka) | |
| ori | $v1, $0, 1 | |
| v3mulu | $v1, $v1, $0 | //mp10 |
| sd | $v0, 16($ka) | |
| v3mulu | $v0, $0, $0 | //mp11 |
| sd | $v1, 24($ka) | |
| v3mulu | $v0, $0, $0 | //mp12 |
| sd | $v1, 32($ka) | |

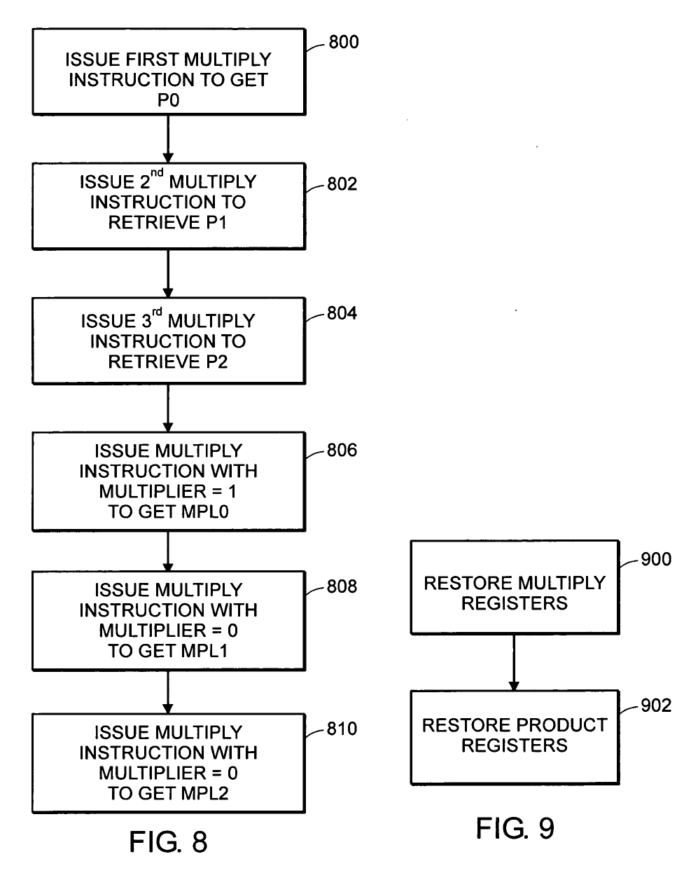

FIG. 8 is a flowchart illustrating the method for saving the current state of the multiplier and product stored in the multiply unit prior to a context switch. As has already been discussed, the product in the multiply unit is in redundant format. Thus, in order to save the state of the product, the redundant format is converted to binary format. The 192-bit×64-bit multiply instruction V3MULU is used to perform the conversion to binary and to move the values from the product registers to the main register file.

At step 800, the product register P0 is returned by issuing a 192-bit×64-bit multiply instruction V3MULU as described previously in conjunction with FIGS. 6 and 7 with the rd parameter identifying the register in the register file in which the value stored in the product P0 register is to be stored and the rs and rt parameters set to ‘0’. This instruction adds 0 to the product, stores the lower 64 bits of the result in the rd register and right shifts the product by 64-bits, that is, bits 127:0 of the result of the first multiplication operation are moved to the P0 register.

At step 802, a second 192-bit×64-bit multiply instruction V3MULU is issued. This instruction adds 0 to the product and stores the lower 64-bits of the result in the rd register in the register file, that is, bits 127:64 of the product. The product is right shifted by 64-bits, that is, bits 191:128 of the product are moved to the P0 register.

At step 804, a third 192-bit multiply instruction V3MULU is issued. This instruction adds 0 to the value stored in the product and returns the lower 64-bits of the result to the rd register in the register file that is, bits 191:129 of the product.

After all 192 bits of the product are returned, the values stored in the multiplier registers are returned by issuing three more multiply instructions.

At step 806, a 192-bit multiply instruction V3MULU with the destination register to which the multiplier value to be returned and rt (multiplier) set to 1 is issued. The first multiply instruction issued to multiply by 1, that is, the multiplier is set to 1. The first multiply instruction retrieves the value stored in the MPL0 register in the multiply unit.

At step, 808, a second multiply instruction is issued to return the value stored in multiplier register MPL1 with the rt (multiplier) and rs parameters set to 0, that is, with the accumulator set to 0. The instruction retrieves the next 64-bits of the multiplier stored in the multiply unit.

At step 810, a third multiply instruction is issued to return the value stored in multiplier register MP2 with the rt and rs parameters set to 0. Thus the 192-bit multiplier value stored in multiplier registers in the multiply unit is read in three instruction cycles.

Table 2 below illustrates a sequence of assembly instructions to restore the saved multiplier context in the multiply unit.

TABLE 2

| | |
|---|---|
| la | $ka, multiplier context |
| ld | $v1, 32($ka) |
| mtm2 | $v0 |
| ld | $v0, 24($ka) |
| mtm1 | $v1 |
| ld | $v0, 16($ka) |
| mtm0 | $v0 |
| ld | $v0, 8($ka) |
| mtp0 | $v1 |
| ld | $v1, 0($ka) |
| mtp1 | $v0 |
| mtp2 | $v1 |

FIG. 9 is a flowchart illustrating the steps for restoring the state of the multiply unit. The state of the multiply unit is restored using the move to product register (MTPx) and move to multiplier register (MTMx) instructions that have been described previously in conjunction with FIG. 3.

At step 900, move to product register commands are issued to convert the values in binary format into redundant format and store the redundant format values into the product registers.

At step 902, move to multiplier register commands are issued to move the stored binary format values into the multiplier registers.

As shown in Table 2, six move instructions to load P0-P2 and MTM0-2 are issued to restore the state of the multiply unit prior to the context switch.

The multiply instruction has been described to perform multiplication operations. However, the multiply instruction can also be used to perform an add operation. When using the multiply instruction to perform addition, the multiplier is set to one and the multiplicand is added to the accumulator. The advantage of the use of the multiply instruction instead of 32-bit addition instruction is that when adding two 64-bit values, an overflow exception is not generated when there is a carry to bit 65, because the product has more than 64-bits.

Another 64-bit multiply and add instruction (VMM0) is provided that combines the multiply instruction and a move to multiplier register instruction. Thus, the VMM0 instruction is functionally equivalent to the two instruction sequence:
VMULU rd, rs, rt
MTM0 rd

In addition to storing the least significant 64-bits of the sum in the rd register, these bits are also stored in the MTM0 register. The format of this instruction is the same as the format described for the 64-bit multiply instruction 400 described in conjunction with FIG. 4 and the 192-bit multiply instruction described in conjunction with FIG. 6, only the opcode value is different. This instruction reduces the number of instruction cycles in the processor for a multiply instruction because the result of the multiply instruction is consumed inside the multiply unit. However, the instruction may affect the latency of the instruction because the VMM0 instruction cannot be pipelined.

The multiply-add instructions are used to perform multiply accumulate instructions that are commonly used in modular exponentiation which is used in cryptographic algorithms.

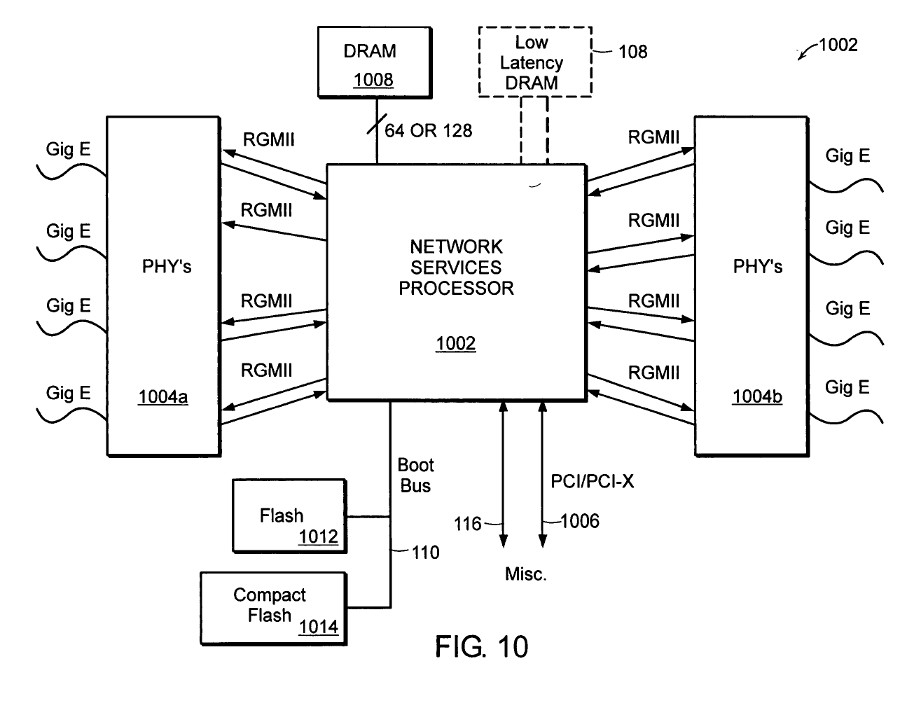

FIG. 10 is a block diagram of a security appliance 1002 including a network services processor 1000 including at least one processor shown in FIG. 1.

The security appliance 102 is a standalone system that can switch packets received at one Ethernet port (Gig E) to another Ethernet port (Gig E) and perform a plurality of security functions on received packets prior to forwarding the packets. For example, the security appliance 1002 can be used to perform security processing on packets received on a Wide Area Network prior to forwarding the processed packets to a Local Area Network.

The network services processor 1000 includes hardware packet processing, buffering, work scheduling, ordering, synchronization, and coherence support to accelerate all packet processing tasks. The network services processor 1000 processes Open System Interconnection network L2-L7 layer protocols encapsulated in received packets.

The network services processor 1000 receives packets from the Ethernet ports (Gig E) through the physical interfaces PHY 1004a, 1004b, performs L7-L2 network protocol processing on the received packets and forwards processed packets through the physical interfaces 1004a, 1004b or through the PCI bus 1006. The network protocol processing can include processing of network security protocols such as Firewall, Application Firewall, Virtual Private Network (VPN) including IP Security (IPSEC) and/or Secure Sockets Layer (SSL), Intrusion detection System (IDS) and Anti-virus (AV).

A Dynamic Random Access Memory (DRAM) controller in the network services processor 1000 controls access to an external DRAM 1008 that is coupled to the network services processor 1000. The DRAM 1008 is external to the network services processor 1000. The DRAM 1008 stores data packets received from the PHYs interfaces 1004a, 1004b or the Peripheral Component Interconnect Extended (PCI-X) interface 1006 for processing by the network services processor 1000.

The network services processor 1000 includes another memory controller for controlling Low latency DRAM 1018. The low latency DRAM 1018 is used for Internet Services and Security applications allowing fast lookups, including the string-matching that may be required for Intrusion Detection System (IDS) or Anti Virus (AV) applications.

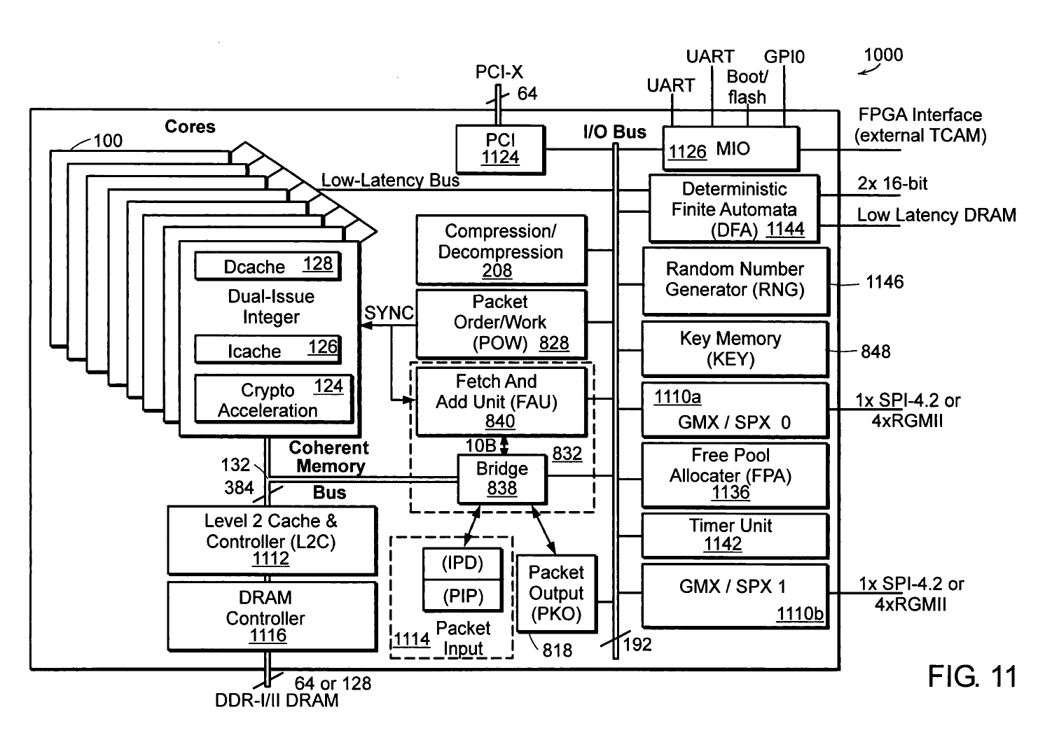

FIG. 11 is a block diagram of the network services processor 1000 shown in FIG. 10. The network services processor 1000 delivers high application performance using at least one processor core 100 as described in conjunction with FIG. 1. Network applications can be categorized into data plane and control plane operations. Each of the processor cores 100 can be dedicated to performing data plane or control plane operations. A data plane operation includes packet operations for forwarding packets. A control plane operation includes processing of portions of complex higher level protocols such as Internet Protocol Security (IPSec), Transmission Control Protocol (TCP) and Secure Sockets Layer (SSL). A data plane operation can include processing of other portions of these complex higher level protocols. Each processor core 100 can execute a full operating system, that is, perform control plane processing or run tuned data plane code, that is perform data plane processing. For example, all processor cores can run tuned data plane code, all processor cores can each execute a full operating system or some of the processor cores can execute the operating system with the remaining processor cores running data-plane code.

A packet is received for processing by any one of the GMX/SPX units 1110a, 810b through an SPI-4.2 or RGM II interface. A packet can also be received by the PCI interface 1124. The GMX/SPX unit performs pre-processing of the received packet by checking various fields in the L2 network protocol header included in the received packet and then forwards the packet to the packet input unit 1114.

The packet input unit 1114 performs further pre-processing of network protocol headers (L3 and L4) included in the received packet. The pre-processing includes checksum checks for Transmission Control Protocol (TCP)/User Datagram Protocol (UDP) (L3 network protocols).

A Free Pool Allocator (FPA) 1136 maintains pools of pointers to free memory in level 2 cache memory 1112 and DRAM. The input packet processing unit 1114 uses one of the pools of pointers to store received packet data in level 2 cache memory or DRAM and another pool of pointers to allocate work queue entries for the processor cores.

The packet input unit 1114 then writes packet data into buffers in Level 2 cache 1112 or DRAM in a format that is convenient to higher-layer software executed in at least one processor core 100 for further processing of higher level network protocols.

The network services processor 100 also includes application specific co-processors that offload the processor cores 100 so that the network services processor achieves high-throughput. The compression/decompression co-processor 1108 is dedicated to performing compression and decompression of received packets. The DFA module 1144 includes dedicated DFA engines to accelerate pattern and signature match necessary for anti-virus (AV), Intrusion Detection Systems (IDS) and other content processing applications at up to 4 Gbps.

The I/O Bridge (IOB) 1132 manages the overall protocol and arbitration and provides coherent I/O partitioning. The IOB 1132 includes a bridge 1138 and a Fetch and Add Unit (FAU) 1140. Registers in the FAU 1140 are used to maintain lengths of the output queues that are used for forwarding processed packets through the packet output unit 1118. The bridge 1138 includes buffer queues for storing information to be transferred between the I/O bus, coherent memory bus, the packet input unit 1114 and the packet output unit 1118.

The Packet order/work (POW) module 1128 queues and schedules work for the processor cores 100. Work is queued by adding a work queue entry to a queue. For example, a work queue entry is added by the packet input unit 1114 for each packet arrival. The timer unit 1142 is used to schedule work for the processor cores.

Processor cores 100 request work from the POW module 1128. The POW module 1128 selects (i.e. schedules) work for a processor core 100 and returns a pointer to the work queue entry that describes the work to the processor core 100.

The processor core 100 includes instruction cache 126, Level 1 data cache 128 and crypto acceleration 124. In one embodiment, the network services processor 100 includes sixteen superscalar RISC (Reduced Instruction Set Computer)-type processor cores. In one embodiment, each superscalar RISC-type processor core is an extension of the MIPS64 version 2 processor core.

Level 2 cache memory 1112 and DRAM memory is shared by all of the processor cores 100 and I/O co-processor devices. Each processor core 100 is coupled to the Level 2 cache memory 1112 by a coherent memory bus 132. The coherent memory bus 132 is the communication channel for all memory and I/O transactions between the processor cores 100, the I/O Bridge (IOB) 1132 and the Level 2 cache and controller 1112. In one embodiment, the coherent memory bus 132 is scalable to 16 processor cores, supports fully coherent Level 1 data caches 128 with write through, is highly buffered and can prioritize I/O.

The level 2 cache memory controller 1112 maintains memory reference coherence. It returns the latest copy of a block for every fill request, whether the block is stored in the L2 cache, in DRAM or is in-flight. It also stores a duplicate copy of the tags for the data cache 128 in each processor core 100. It compares the addresses of cache block store requests against the data cache tags, and invalidates (both copies) a data cache tag for a processor core 100 whenever a store instruction is from another processor core or from an I/O component via the I/O Bridge 1132.

After the packet has been processed by the processor cores 100, a packet output unit (PKO) 1118 reads the packet data from memory, performs L4 network protocol post-processing (e.g., generates a TCP/UDP checksum), forwards the packet through the GMX/SPC unit 1110a, 1110b and frees the L2 cache/DRAM used by the packet.

The invention has been described for a processor core that is included in a security appliance. However, the invention is not limited to a processor core in a security appliance. The invention applies to multiply instructions that can be used in any pipelined processor.

While this invention has been particularly shown and described with references to preferred embodiments thereof, it will be understood by those skilled in the art that various changes in form and details may be made therein without departing from the scope of the invention encompassed by the appended claims.

What is claimed is:

1. A processor comprising:
a multiply unit including a multiplier register and a product register; and
a register file including a plurality of general purpose registers for storing a result of a multiplication operation in the multiply unit; wherein the multiplier register is loaded once with a multiplier value prior to the start of the multiplication operation, the multiplication operation including a plurality of multiplication instructions, the intermediate results of each multiplication instruction being shifted and stored in the product register so that carries between intermediate results are handled within the multiply unit.

2. The processor of claim 1, wherein the multiplication operation is one of a sequence of operations performed for modular exponentiation.

3. The processor of claim 1, wherein the product register is cleared when the multiplier register is loaded.

4. The processor of claim 1, wherein the multiply instruction is used to perform an add operation by storing a value of 1 in the multiplier register.

5. The processor of claim 1, wherein the multiplier is loaded into a multiplier register using a multiplier register load instruction.

6. The processor of claim 1, wherein the multiply instruction performs a multiplication operation for a 64-bit multiplier and a 64-bit multiplicand.

7. The processor of claim 1, wherein the multiply instruction performs a multiplication operation for a 192-bit multiplier and a 64-bit multiplicand.

8. The processor of claim 7, wherein the 192-bit multiplier is stored in the multiplier register in the multiply unit prior to the start of the multiplication operation.

9. The processor of claim 1, wherein the intermediate result is stored in redundant format.

10. A method for accelerating modular exponentiation comprising:
loading a multiplier into a multiplier register in a multiply unit prior to the start of a multiplication operation, the multiplication operation including a plurality of multiply instructions;
executing one of the multiply instructions in the multiply unit;
shifting intermediate results of the multiplication instruction;
storing the shifted intermediate results in a product register in the multiply unit so that carries between intermediate results are handled within the multiply unit; and
storing a result of the multiplication operation in the multiply unit in a general purpose register in a register file.

11. The method of claim 10, wherein the multiplication operation is one of a sequence of operations performed for modular exponentiation.

12. The method of claim 10, wherein the product register is cleared when the multiplier register is loaded.

13. The method of claim 10, wherein the multiply instruction is used to perform an add operation by storing a value of 1 in the multiplier register.

14. The method of claim 10, wherein the multiplier is loaded using a multiplier load instruction.

15. The method of claim 10, wherein the multiply instruction performs a multiplication operation for a 64-bit multiplier and a 64-bit multiplicand.

16. The method of claim 10, wherein the multiply instruction performs a multiplication operation for a 192-bit multiplier and a 64-bit multiplicand.

17. The method of claim 16, wherein the 192-bit multiplier is stored in the multiplier register in the multiply unit prior to the start of the multiplication operation.

18. The method of claim 10, wherein the intermediate result is stored in redundant format.

19. A processor comprising:
means for loading a multiplier into a multiplier register in a multiply unit prior to the start of a multiplication operation, the multiplication operation including a plurality of multiply instructions;
means for executing a multiply instruction in the multiply unit;
means for shifting intermediate results of the multiplication instruction; and
means for storing the shifted intermediate results in a product register in the multiply unit so that carries between intermediate results are handled within the multiply unit.
